(19) United States
(12) Patent Application Publication
(10) Pub. No.: US 2018/0189499 A1
(43) Pub. Date: Jul. 5, 2018

(54) DYNAMIC SECURITY REPORT GENERATOR

(71) Applicant: Trinity Guard, LLC, Houston, TX (US)

(72) Inventor: Anthony Perera, Meadows Place, TX (US)

(21) Appl. No.: 15/397,635

(22) Filed: Jan. 3, 2017

(51) Int. Cl. G06F 21/57

(52) U.S. Cl. CPC G06F 21/577; G06F 2221/033

(57) ABSTRACT

A system provides a user interface for selecting one of a predefined plurality of computer security reports in a user interface that allows creating a new report. If one of the predefined reports is selected, the report may be produced in a desired format. If a new report is indicated, a menu of computer security data collectors is provided and a computer security data collector is selected for the new report. Selection criteria may be received via the user interface to limit the computer security data collected by the collector. The selection criteria are then associated with the new report and the new report may be added to the plurality of predefined reports. The new report may then be produced and provided to the user.

### TECHNICAL FIELD

The present invention relates to the field of security monitoring, and in particular to a technique for allowing a user to create security reports dynamically from a database.

### BACKGROUND ART

Many computers are controlled by operating systems that provide automatic collection and logging of a large number of security attributes, such as the name of the user logging into the system, when logins and logouts occur, etc. The best security management practices for such a computer in many cases requires generating security reports from the logged security data. However, some operating systems provide so many security attributes and collect so much data about those attributes, that a report on every security attribute and all security data would be overwhelming and impossible to use effectively. Software vendors have provided reporting systems that allow producing reports on subsets of the security attributes and filtering the security data to generate reports of a useful size and complexity, but those reports have been limited to only those reports that the software vendor considered useful. Security managers would like the flexibility to design custom reports on the fly, using different collections of security attributes than those chosen by software vendors.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram of a computer system for use with embodiments disclosed below.

FIGS. 2-4 are flowcharts illustrating techniques for dynamically generating security reports according to various embodiments.

FIG. 5 is block diagram illustrating a database for use with the dynamic security reporting system according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” can refer to a single computer or a plurality of computers working together to perform the function described as being performed on or by a computer system.

As used herein, the term “database” can refer to any structured technique for storing data that allows the data to be efficiently accessed, managed, and updated. Although many databases may be relational databases storing data in rows and tables, other forms of databases can be used. In some embodiments, the operating system of the computer system may provide a database as part of the operating system, including database software for accessing and manipulating the database. In other embodiments, third party vendors may provide database software for creating and managing databases. As used herein, a database can refer to a single database or a plurality of databases that together may store the data described herein as being stored in the database.

As used herein, the term “data collector” can refer to code that is capable of extracting and processing one or more computer security data elements from the operating system of the computer system.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

Embodiments may be implemented in one or a combination of hardware, firmware, and software. Embodiments may also be implemented as instructions stored on a computer-readable storage medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Embodiments, as described herein, may include, or may operate on, logic or a number of components, modules, or mechanisms. Modules may be hardware, software, or firmware communicatively coupled to one or more processing elements to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

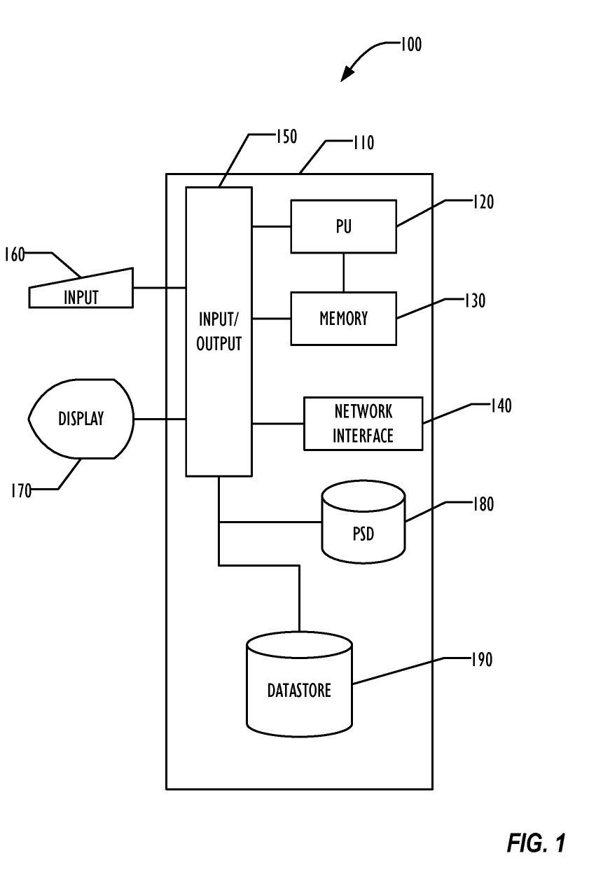

FIG. 1 is a block diagram of a computer system 100 according to one embodiment, for use with the techniques described below. The elements illustrated in FIG. 1 are illustrative and by way of example only, and do not include every component of every possible embodiment of the computer system 100. One example of such a computer system is the IBM® Power Systems computer, running the IBM i operating system. (IBM is a registered trademark of International Business Machines Corporation.)

A system unit 110, which may be a freestanding unit or a rack-mounted unit typically contains many of the components of the computer system 100. A programmable processing element 120 provides processing power for the computer system 100. A memory 130 provides working storage for the processing element 120, and may be connected to the processing element 120 using any type of interconnect, including busses and point-to-point interconnects. In some embodiments, some of memory 130 may be implemented on chip with the processing element 120, providing high-speed cache or other functionality. Programs executing on the computer system 100 are typically loaded into the memory 130, then executed. An input/output component 150 may connect to the processing element 120 and memory 130 for providing an interface for various types of input/output devices. In some embodiments, one or more input devices 160, such as a keyboard or a mouse, may be connected via the input/output interface 150. In some embodiments, one or more display devices 170 may also be connected to the computer system 100 via the input/output interface 150, either directly or via an intermediate device not illustrated in FIG. 1. Some embodiments, typically rack-mounted embodiments, may omit either or both of the input device and display unit as desired, typically providing input and output via the network interface 140 across one or more networks.

A network interface 140 provides connectivity to one or more networks of any desired type, including the Internet, and may be connected to the processing element 120 and memory 130 via the input/output interface 150. A program storage device 180 may provide storage for storing software and data via the input/output interface 150 to the processing element 120 and memory 130. Similarly a datastore 190 may provide storage for a database used as described below, and may be connected via the input/output interface 150.

Although only one of each type of component is illustrated in FIG. 1, embodiments of the computer system 100 may contain multiple of each type of component. Instead of being connected via the input/output interface 150 as illustrated in FIG. 1, other connectivity between components of the computer system may be used. Items shown as separate components in FIG. 1 may be implemented as a combined component if desired, and the arrangement of the components in FIG. 1 is illustrative and by way of example only.

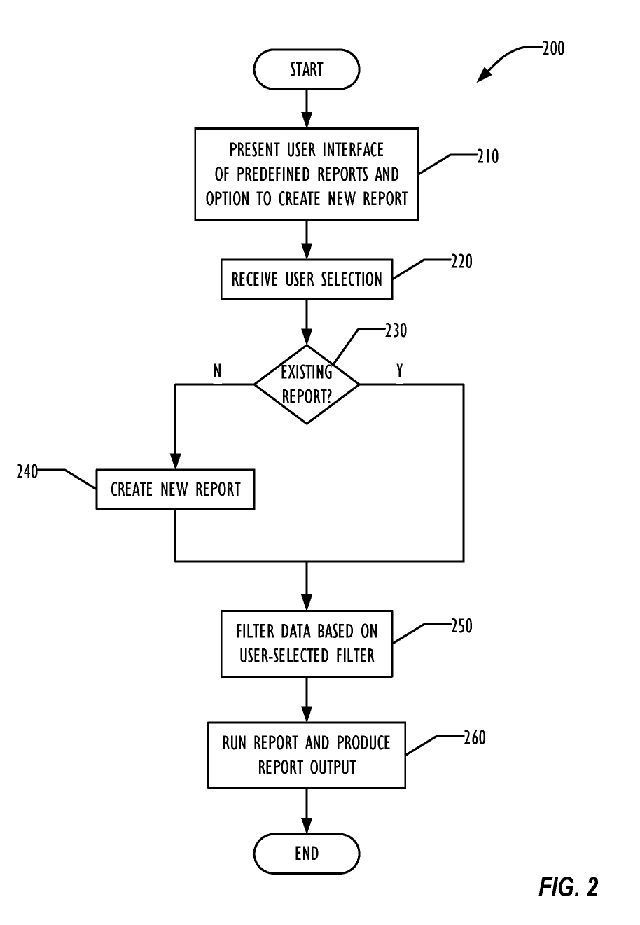

Turning now to FIG. 2, a flowchart 200 illustrates a technique for improving usability of computer security data by allowing the use of dynamically created custom security attribute reports. In block 210, a user interface is presented by the computer 100. The user interface in one embodiment is a menu-driven user interface, listing available pre-defined computer security reports, as well as an option to create a new computer security report. Various embodiments may use different user interfaces, including graphical and character-based user interfaces, and selecting one of the pre-defined computer security reports may involve any type of user input, including checkboxes, clicking on a field with a user input device such as a mouse, character entry fields, etc.

In block 220, the user input selecting either a pre-defined report or the option to create a new computer security report is received. In block 230, if the user input indicates that an existing computer security report should be run, in block 250 the user interface provides the user with the opportunity to filter the computer security data. Filtering the data may be desirable because of the volume of the data available for the report. One example of filtering the data may be to limit the report to data within a certain time range. Another example is to limit the report to data for a certain user or group of users, e.g., all users whose user names begin with “SYS.” Any desired type of filtering may be used. In one embodiment, multiple filters may be applied to the computer security data to be reported, e.g., all users whose user names begin with “A” and all data collected last Monday between 8:00 am and 9:00 am.

The report is then run in block 260 on the filtered computer security data, producing a report output. In one embodiment, a dynamic database query is generated from the set of query criteria associated with the computer security report. In one embodiment, the reporting function may allow the user to specify a one of a plurality of types of report format, e.g., plain text, hypertext markup language (HTML), etc. Any desired type of output format may be used. In some embodiments, the report may be displayed for the requesting user on a display unit such as display unit 170, or may be stored to a file for later use, may sent to another computer system, or any combination of those actions.

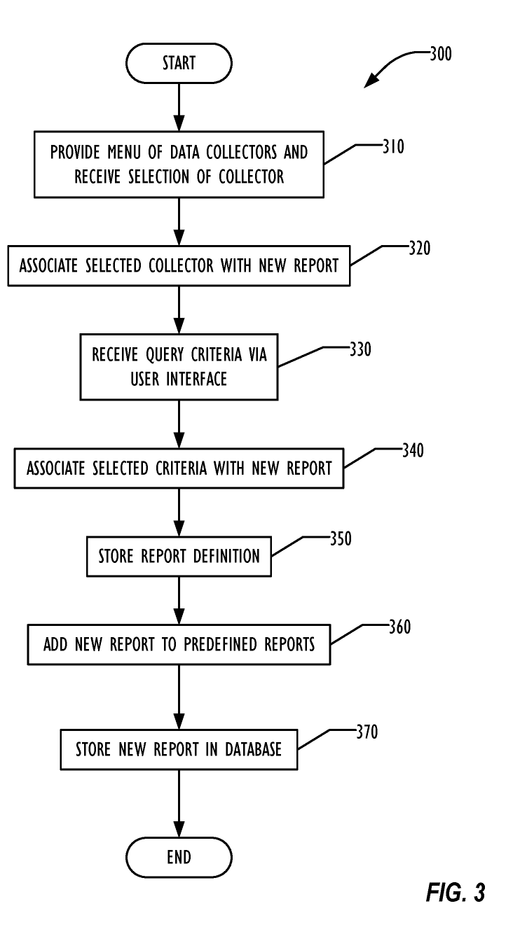

But if the user selected the option to create a new report, the new computer security report is created in block 240, as further described in FIG. 3. The filtering of block 250 and running of the report of block 260 proceeds just as with the pre-defined computer security reports.

FIG. 3 is a flowchart 300 illustrating a technique for creating a new computer security report according to one embodiment. In block 310, a menu of available data collectors is presented in the user interface. The user interface in one embodiment provides information about what computer security data elements are processed by the data collectors, either automatically, or upon receipt of a user input requesting such information. Data collectors may be overlapping in the computer security data elements that may be processed by the data collectors. For example, data collector 1 may be capable of processing computer security data elements A, B, C, and D, while data collector 2 may be capable of processing computer security data elements A, C, D, and E. Data collectors in one embodiment are stored in the database that stores the computer security reports. In other embodiments, the data collectors are stored in a different database than the computer security reports.

In block 320, the data collector is associated with the new computer security report. In one embodiment, only a single data collector can be associated with a computer security report. In other embodiments, multiple data collectors can be associated with a single computer security report.

The data collector is configured to collect a predefined set of computer security data elements from the operating system of the computer system 100. A data collector may be capable of collecting computer security data corresponding to more computer security data elements than are desired for the new computer security report. Therefore, in block 330, embodiments may receive a set of one or more query criteria for selecting a subset of the predefined set of computer security data elements. For example, data collector may be configured to be able to collect computer security data elements A, B, C, and D, extracting or requesting and receiving the data from the operating system. If the report is only interested in data element A, the data collector may be configured to only provide data element A when running the new computer security report, instead of A, B, C, and D. The query criteria may then be associated with the new report in block 340, defining the report.

Because in many cases a newly defined computer security report may be useful to run multiple times, in block 350 the definition of the new computer security report may be stored in the database, including the query criteria for the data collector associated with the new computer security report. The new computer security report may be made available in menu of available predefined computer security reports in the user interface in block 360, storing the new computer security report in the database for later use. In one embodiment, the predefined computer security reports are defined as rows in a table in the database, each row indicating the data collector and the selection criteria, along with other data such as a name for the report. However, any desired way of storing the definition of computer security reports in the database may be used.

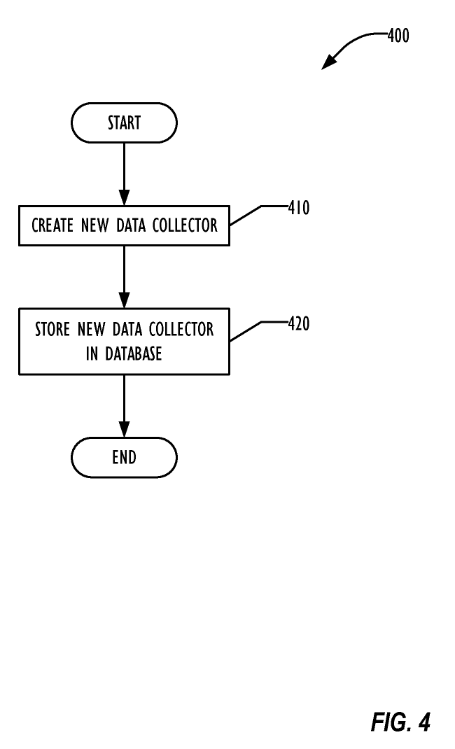

FIG. 4 is a flowchart 400 illustrating a technique for creating a new data collector for use in computer security reports. In block 410, the new data collector is created. In one embodiment, creating the data collector involves writing the needed code to interface with the operating system to collect or extract the desired computer security data elements from the operating system. This may involve invoking any application programming interface (API) used by the operating system for providing the computer security data element, with different APIs used for the various computer security data elements the data collector is configured to collect. In one embodiment, the data collector defines a set of query criteria for querying a database of computer security data generated by the operating system. Because each computer security data element may be a different type of data, e.g., binary data, text field, structured fields with multiple subfields, etc., information about the attributes of each computer security data field may be stored with the instructions that when the data collector is executed cause the computer system to obtain the desired computer security data and process it. The data collector not only obtains the data from the operating system, but formats the computer security data based on the attributes of the computer security data elements and the desired output format. For example, the data collector may convert binary data into character numeric data for display in the report, or may convert bits into text strings that define certain attributes. Any type of formatting instructions may be provided in the data collector. This may involve writing code for obtaining and formatting the data.

In one embodiment, the data collector code and the information about the computer security data elements processed by the data collector code may be stored in block 420 as a row in the database.

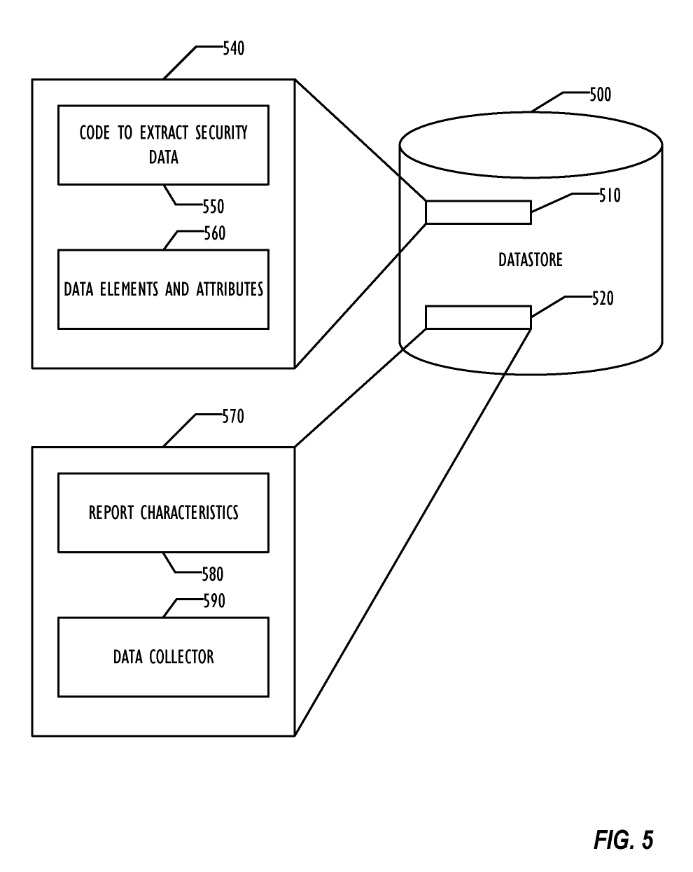

FIG. 5 is a block diagram illustrating a datastore 500 that serves as the database described above according to one embodiment. As indicated in FIG. 5, tables 510 and 520 contain rows 540 and 570 that define data collectors and reports, respectively. Although illustrated as a single table, the database may structure the data in multiple tables for ease of use or performance reasons. In addition, the reports and data collectors may be stored in a composite table if desired.

Rows 540 may contain columns or fields 550 for the instructions that are to be executed by the data collector corresponding to the row 540. In addition, rows 540 may contain fields 560 for each of the computer security data elements to be collected by the data collector. The fields 560 may contain whatever information is needed to identify the data elements and their attributes, such as data type. In addition, the row 540 for a data collector may provide any other information that may be useful or desired, such as a name for the data collector, information about its creator, etc.

Rows 570 define the predefined computer security reports stored in the database 500. The row 570 identifies the associated data collector in field 590, as well as report characteristics 580, such as criteria used for subsetting the data collectable by the data collector identified in field 590, as well as report formatting information and output destination information.

By keeping a database of predefined reports and data collectors, and allowing new reports to be dynamically defined using the data collectors, a more flexible system provides users with the ability to define custom computer security reports that may be more useful than the previously defined reports, and add the newly defined report to the set of predefined computer security reports available in the database.

While certain exemplary embodiments have been described in details and shown in the accompanying drawings, it is to be understood that such embodiments are merely illustrative of and not devised without departing from the basic scope thereof, which is determined by the claims that follow.

We claim:

1. A method of improving usability of computer security data, comprising:
providing in a user interface, by a computer system, a first menu for selecting a predefined computer security report of a plurality of predefined computer security reports and an option to create a new computer security report, wherein the plurality of predefined computer security reports are stored in a database;
providing a second menu of computer security data collectors in the user interface responsive to receiving a selection of the option;
receiving a selection of a computer security data collector via the user interface, the computer security data collector configured to collect a predefined set of computer security data elements from an operating system of the computer system;
creating a definition for the new computer security report, comprising:
associating the computer security data collector with the new computer security report;
receiving a set of query criteria for selecting a subset of the predefined set of computer security data elements;
associating the set of query criteria with the new computer security report; and
storing the definition of the new computer security report in the database.

2. The method of claim 1, further comprising:
adding the new computer security report to the first menu.

3. The method of claim 1, further comprising:
creating a new computer security data collector for collecting a predetermined set of computer security data elements from the operating system; and
storing the new computer security data collector and information about the predetermined set of computer security data elements in the database.

4. The method of claim 3, wherein the computer security data collector comprises:
instructions that when executed cause the computer system to collect computer security data information corresponding to the predetermined set of computer security data elements from the operating system; and
instructions that when executed cause the computer system to store the collected computer security data information in a table of the database.

5. The method of claim 1, further comprising:
executing the computer security data collector, generating entries in a table of the database associated with the new computer security report;
generating a dynamic database query from the set of query criteria associated with the new computer security report;
querying the table of the database, producing the new computer security report; and
outputting the new computer security report in a selected format.

6. The method of claim 5, further comprising:
filtering the new computer security report based on a user-selected filter.

7. A non-transitory computer readable medium, on which are stored instructions for improving usability of computer security data, comprising instructions that when executed cause a computer to:
display in a user interface a first menu identifying a plurality of predefined computer security reports and an option to create a custom computer security report, wherein the plurality of predefined computer security reports is stored in a database;
receive a selection of the option to create the custom computer security report;
create the custom computer security report responsive to receiving the selection;
provide a second menu of computer security data collectors in the user interface;
receive a selection of one or more computer security data collectors via the user interface; and
create the custom computer security report from the selected one or more computer security data collectors.

8. The computer readable medium of claim 7, wherein the instructions further comprise instructions that when executed cause the computer to:
store the custom computer security report as a predefined computer security report in the database; and
add the custom computer security report to the first menu.

9. The computer readable medium of claim 7, wherein the instructions further comprise instructions that when executed cause the computer to:
create a plurality of computer security data collectors; and
store the plurality of computer security data collectors in the database.

10. The computer readable medium of claim 9, wherein each of the plurality of computer security data collectors comprises:
instructions that when executed cause the computer security data collector to collect a selected computer security data from an operating system generating the computer security data; and
instructions that when executed cause the computer security data collector to format the selected computer security data, based on attributes of the selected computer security data.

11. The computer readable medium of claim 7, wherein the instructions further comprise instructions that when executed cause the computer to:
execute the custom computer security report.

12. The computer readable medium of claim 7, wherein the instructions further comprise instructions that when executed cause the computer to:
filter the computer security data based on a user-selected filter.

13. A computer system configured to produce computer security reports, comprising:
a processor;
a memory, coupled to the processor, on which are stored instructions for improving the usability of computer security data, comprising instructions that when executed cause the processor to:
display in a user interface a first menu identifying a plurality of predefined computer security reports and an option to create a custom computer security report, wherein the plurality of predefined computer security reports are stored in a database;
receive a selection of the option to create the custom computer security report;
create the custom computer security report responsive to receiving the selection;
provide a second menu of computer security data collectors in the user interface;
receive a selection of one or more computer security data collectors via the user interface; and
create the custom computer security report from the selected one or more computer security data collectors.

14. The computer system of claim 13, wherein the instructions further comprise instructions that when executed cause the processor to:
store the custom computer security report as a predefined computer security report in the database; and
add the custom computer security report to the first menu.

15. The computer system of claim 13, wherein the instructions further comprise instructions that when executed cause the processor to:
create a plurality of computer security data collectors; and
store the plurality of computer security data collectors in the database.

16. The computer system of claim 15, wherein each of the plurality of computer security data collectors comprises:
instructions that when executed cause the computer security data collector to collect a selected computer security data from an operating system generating the selected computer security data; and
instructions that when executed cause the computer security data collector to format the selected computer security data, based on attributes of the selected computer security data.

17. The computer system of claim 13, wherein the instructions further comprise instructions that when executed cause the processor to:
execute the custom computer security report.

18. The computer system of claim 13, wherein the instructions further comprise instructions that when executed cause the processor to:
filter the computer security data reported by the custom computer security report based on a user-selected filter.
